(19) United States
(12) Patent Application Publication
(10) Pub. No.: US 2024/0152773 A1
(43) Pub. Date: May 9, 2024

(54) DEVICE AND COMPUTER-IMPLEMENTED METHOD FOR DETERMINING A STATE OF A TECHNICAL SYSTEM

(71) Applicant: Robert Bosch GmbH, Stuttgart (DE)

(72) Inventor: Juergen Luettin, Renningen (DE)

(21) Appl. No.: 18/500,173

(22) Filed: Nov. 2, 2023

(30) Foreign Application Priority Data
Nov. 8, 2022 (DE) 10 2022 211 801.4

(51) Int. Cl. G06N 5/02; G06F 18/24

(52) U.S. Cl. CPC G06N 5/02; G06F 18/24765

(57) ABSTRACT

Device and computer-implemented method for determining a state of a technical system, in particular of an infrastructure element or of a road user. A first node represents a first object, in particular the technical system, a second node represents a second object, in particular a further infrastructure element or a further road user. An edge between the first node and the second node represents a relationship between the objects. A prediction is determined which characterizes a behavior of one of the objects. The determination is in accordance with information about the objects and in accordance with a representation of a knowledge graph which includes the first node, the second node, and the edge. The state is determined in accordance with the prediction.

### CROSS REFERENCE

The present application claims the benefit under 35 U.S.C. § 119 of DE 10 2022 211 801.4 filed on Nov. 8, 2022, which is expressly incorporated herein by reference in its entirety.

### FIELD

The present invention relates to a device and a computer-implemented method for determining a state of a technical system.

### SUMMARY

According to an example embodiment of the present invention, a computer-implemented method for determining a state of a technical system, in particular of an infrastructure element or of a road user, provides that a first node represents a first object, in particular the technical system, wherein a second node represents a second object, in particular a further infrastructure element or a further road user, wherein an edge between the first node and the second node represents a relationship between the objects, wherein a prediction is determined, which characterizes a behavior of one of the objects, said determination being in accordance with information about the objects and in accordance with a representation of a knowledge graph that comprises the first node, the second node, and the edge, and wherein the state is determined in particular in order to control the technical system in accordance with the prediction. The knowledge graph represents the infrastructure elements and road users as nodes and forms a relationship between static infrastructure elements and dynamic road users on the basis of the edges or an absence of edges.

According to an example embodiment of the present invention, the first object is preferably associated with a first class, wherein the first class is represented by the first node, or wherein the second object is associated with a second class, wherein the second class is represented by the second node. As a result, the knowledge graph compactly stores the knowledge for individual classes.

In one example embodiment of the present invention, the first class represents a passenger car, a truck, a three-wheeled vehicle, a two-wheeled vehicle, a horse rider, a pedestrian, or the first class represents a road segment, an intersection, a lane, a guardrail, a warning beacon, a traffic light, a footpath, a road marking, or a roadway boundary.

In one example embodiment of the present invention, the second class represents a passenger car, a truck, a three-wheeled vehicle, a two-wheeled vehicle, a horse rider, a pedestrian, or the second class represents a road segment, an intersection, a lane, a guardrail, a warning beacon, a traffic light, a footpath, a road marking, or a roadway boundary.

In one example embodiment of the present invention, the objects are infrastructure elements associated with one another, wherein the edge represents the relationship of the infrastructure elements associated with one another, in particular interconnected lanes of a multi-lane road or a traffic light relevant to a lane, a traffic sign or a traffic regulation.

In one example embodiment of the present invention, the objects are road users associated with one another, wherein the edge represents the relationship of the road users associated with one another, in particular road users located in the same lane or located in different lanes of a multi-lane road.

In one example embodiment of the present invention, the first object is an infrastructure element and the second object is a road user, the two being associated with one another, wherein the edge represents the relationship between them.

In one example embodiment of the present invention, a further node represents environment information, in particular a time of day, a day of the week, visibility, a temperature, a roadway requirement, a roadway type, wherein a further edge between the further node and the first node represents a relationship between the environment information and the first object.

In one example embodiment of the present invention, a further node represents a traffic regulation or a behavior pattern, wherein a further edge between the further node and the first node represents a relationship between the first object and the traffic regulation represented by the further node or the behavior pattern represented by the further node.

According to an example embodiment of the present invention, the representation of the knowledge graph, which comprises the nodes and edges, is preferably trained in accordance with training data comprising information about the objects, wherein two objects are classified in one class in each case, wherein an edge which represents a relationship between two nodes of the knowledge graph, which in each case represent one of the classes, is determined by means of an ontology which specifies the relationships between the two classes which the two nodes represent.

According to an example embodiment of the present invention, the prediction is preferably determined in accordance with test data which comprise information, unknown in the training, which is mapped onto the prediction by the representation of the knowledge graph, which representation is trained with the training data.

According to an example embodiment of the present invention, a device for determining a state of a technical system comprises at least one processor and at least one memory, wherein the at least one memory comprises instructions, during the execution of which by the at least one processor the method is executed, and wherein the at least one processor is designed to execute the instructions. This device has advantages that correspond to those of the method.

According to an example embodiment of the present invention, a computer program comprises computer-readable instructions, during the execution of which by a computer the method of the present invention is executed. This has advantages that correspond to those of the method.

Further advantageous embodiments of the present invention can be found in the following description and the figures.

### BRIEF DESCRIPTION OF THE DRAWINGS

FIG. 1 shows a schematic representation of a device for determining a state of a technical system, according to an example embodiment of the present invention.

FIG. 2 shows a schematic representation of an environment of the technical system, according to an example embodiment of the present invention.

FIG. 3 shows a schematic representation of a knowledge graph, according to an example embodiment of the present invention.

FIG. 4 shows steps in a method for determining the state and control of the technical system, according to an example embodiment of the present invention.

FIG. 5 shows a schematic representation of an ontology, according to an example embodiment of the present invention.

### DETAILED DESCRIPTION OF EXAMPLE EMBODIMENTS

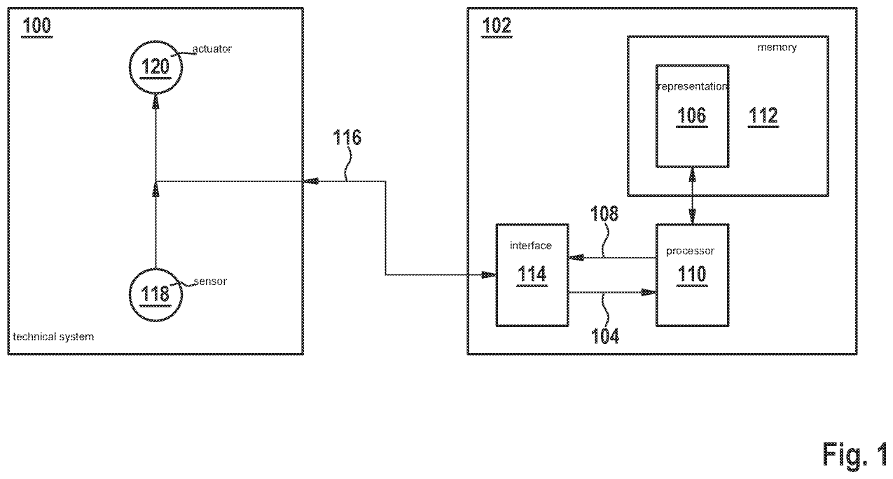

FIG. 1 schematically shows a technical system 100 and a device 102 for determining a state of the technical system 100. In one embodiment, the device 102 is designed to control the technical system 100.

The technical system 100 is a physical system, for example a partially autonomous machine, for example, a robot system or a vehicle or an information determination system or monitoring system.

The device 102 is designed to map information 104 about objects onto a prediction 108 in accordance with a representation 106 of a knowledge graph, which prediction characterizes a behavior of an object. In the example, the objects are objects that exist in reality. The information 104 comprises, for example, a position or movement path of the objects or their state. The prediction 106 comprises, for example, a position or a movement path of the object. The information 104 comprises, for example, a time series representing the positions or states in particular in their real temporal sequence.

The knowledge graph is represented, for example, by triplets each comprising two nodes and an edge. The edge indicates the relationship that the knowledge graph stores for these two nodes. The representation 106 of the knowledge graph comprises, for example, an embedding of the knowledge graph in a state space.

The information 104 is mapped, for example, onto a first point in the state space. The first point is mapped onto a second point in the state space, for example, in accordance with a representation of a predetermined edge, i.e., a predetermined relationship. The prediction 108 is represented, for example, by a third point in the state space which is closer to the second point than are other points in the state space. The third point is mapped, for example, from the state space onto the prediction 108. It can be provided that the information 104, the prediction 108 and the predetermined edge are variables, for example vectors, from the state space which, without being mapped into the state space, are used for determining the prediction 108.

The device 102 is designed to determine the state in accordance with the prediction. This means that the device 102 comprises a sensor for the state.

In one embodiment, the device 102 is also designed to control the technical system 100 in accordance with the prediction 108.

The device 102 comprises at least one processor 110 and at least one memory 112. The at least one memory 112 comprises instructions, during the execution of which by the at least one processor 110 a method described below is executed. The at least one processor 110 is designed to execute the instructions.

The device 102 comprises an interface 114 which is designed to detect the information 104 via a connection 116 from a sensor 118 and to control an actuator 120 via the connection 116.

In the example, the sensor 118 and the actuator 120 are integrated into the technical system 100. The sensor 118, the actuator 120 or both can be integrated into the device 102. The device 102 can be integrated into the technical system 100.

In the example, the sensor 118 comprises a detection system which is designed to monitor the technical system 100 and/or its environment and to provide the information 104. The information 104 comprises, for example, information about the position, the movement path or the state of the objects that are contained in a signal of the sensor 118.

The state can characterize a direction of travel, a speed or an acceleration or a steering angle. The state can characterize a signal, for example a traffic light, i.e., for example, red, amber or green, or information on a traffic sign, for example a speed limit or a permitted or prohibited direction of travel.

The sensor 118 can comprise an object recognition system by means of which an object can be recognized and classified into a class from a set of predefined classes.

The sensor 118 can comprise an object tracking system by means of which a position or movement path of the objects is tracked over a period of time.

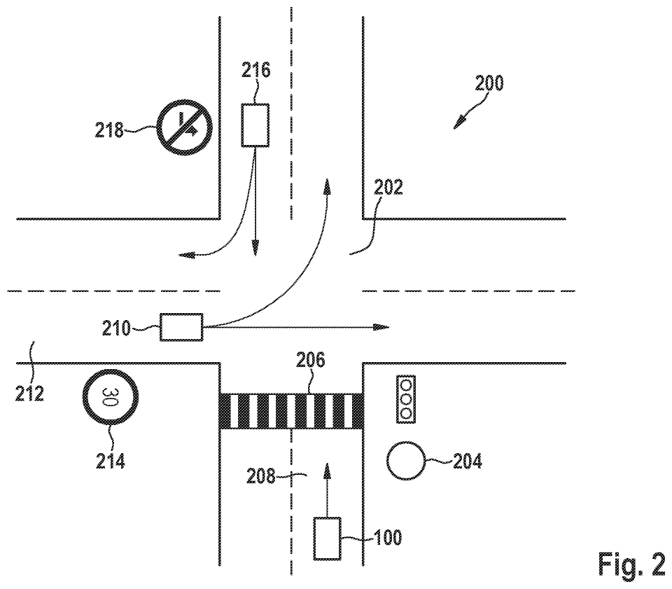

FIG. 2 shows a schematic representation of an environment 200 of the technical system 100. In the example, the technical system 100 is a first road user, for example a partially autonomous vehicle, which in the region of an intersection 202 is moving towards said intersection.

FIG. 2 shows a second road user 204, for example a pedestrian, who in the region of the intersection 202 is moving towards a pedestrian crossing 206, which passes between the vehicle and the intersection 202 over a first roadway 208 on which the vehicle is located.

FIG. 2 shows a third road user 210 which in the region of the intersection 202 is moving towards the intersection 202 on a second roadway 212 which crosses the first roadway 208 at the intersection 202. The third road user 210 is, for example, a further vehicle.

In the example, the third road user 210 is passing a first traffic sign 214 which symbolizes a first traffic regulation. In the example, the first traffic sign 214 symbolizes a speed limit of 30 km/h.

FIG. 2 shows a fourth road user 216 which in the region of the intersection 202 is moving towards the intersection 202 on the first roadway 208 on a side of the intersection 202 opposite the first road user. The fourth road user 216 is, for example, a further vehicle. In the example, the first road user and the fourth road user 216 are driving on different lanes of the first roadway 208.

In the example, the fourth road user 216 is passing a second traffic sign 218 which symbolizes a second traffic regulation.

In the example, the second traffic sign 218 symbolizes a prohibition against turning left.

The first traffic sign 214, the second traffic sign 218 and the pedestrian crossing 206 are examples of infrastructure elements.

The road users and the infrastructure elements are examples of objects.

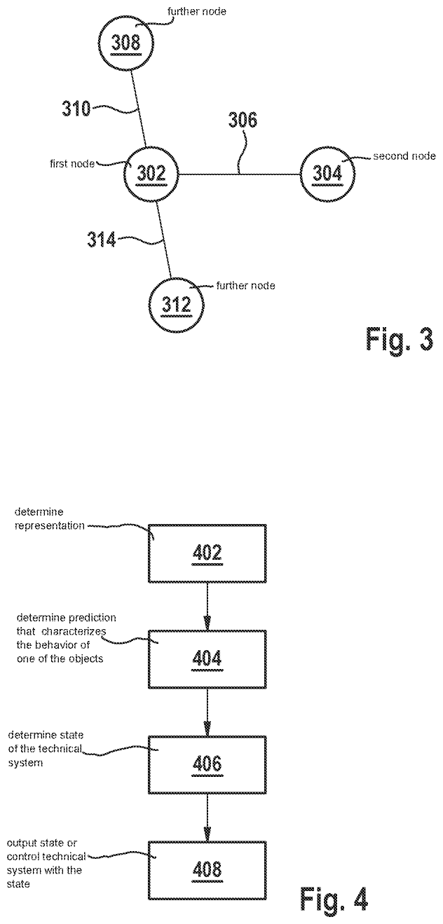

FIG. 3 schematically shows part 300 of the knowledge graph.

The knowledge graph comprises a first node 302, which represents a first object. In the example, the first object is associated with a first class. In the example, the first class is represented by the first node 302.

In the example, the first object is the technical system 100. In the example, the first class is a “passenger car”.

The first object may be another road user or an infrastructure element. The first class may represent the other road user or the infrastructure element.

The first class may, for example, represent a passenger car, a truck, a three-wheeled vehicle, a two-wheeled vehicle, a horse rider, or a pedestrian.

The first class may represent, for example, a road segment, an intersection, a lane, a guardrail, a warning beacon, a traffic light, a footpath, a road marking, traversable or non-traversable contamination, a road or a roadway boundary.

It can be provided that the first class is predefined or is recognized by means of the object recognition system.

The knowledge graph comprises a second node 304, which represents a second object. In the example, the second object is an infrastructure element or another road user.

In the example, the second object is associated with a second class. The second class is represented by the second node 304.

For a road user, the second class may represent a passenger car, a truck, a three-wheeled vehicle, a two-wheeled vehicle, a horse rider or a pedestrian.

For an infrastructure element, the second class may represent a road segment, an intersection, a lane, a guardrail, a warning beacon, a traffic light, a footpath, a road marking, traversable or non-traversable contamination, a road or a roadway boundary.

It can be provided that the second class is predefined or is recognized by means of the object recognition system.

The knowledge graph comprises an edge 306 between the first node 302 and the second node 306. The edge 306 represents a relationship between the first object and the second object.

The objects may be infrastructure elements associated with one another, wherein the edge represents the relationship of the infrastructure elements associated with one another. For example, lanes of a multi-lane road or traffic lights relevant to a lane are represented by corresponding nodes and a corresponding edge.

The objects may be road users associated with one another, wherein the edge represents the relationship of the road users associated with one another. For example, road users located in the same lane or located on different lanes of a multi-lane road are represented by corresponding nodes and a corresponding edge.

It can be provided that the first object is an infrastructure element and the second object is a road user, the two being associated with one another, wherein the edge represents the relationship between them.

In one embodiment, the knowledge graph comprises a further node 308 which represents environment information. The environment information is, for example, a time of day, a day of the week, visibility, a temperature, a roadway condition, a roadway type.

A further edge 310 between the further node 308 and the first node 302 represents a relationship between the environment information and the first object. Environment information can likewise be provided for the second node 304.

In one embodiment, the knowledge graph comprises a further node 312, which represents a traffic regulation or a behavior pattern. A further edge 314 between the further node 312 and the first node 302 represents a relationship between the first object and the traffic regulation represented by the further node 312 or the behavior pattern represented by the further node 312. A traffic regulation or a behavior pattern can also be provided for the second node 304.

The behavior pattern represents, for example, a behavior followed by most people. For example, the behavior pattern represents the fact that people usually follow a signal of a traffic light or comply with a safety distance from a road user. The behavior pattern can also anticipate a behavior of another person, such as merging into a common lane.

These nodes and edges are examples of relationships between the objects.

In the example shown in FIG. 2, for example, detected objects that represent the first road user, the second road user 204, the third road user 210, and the fourth road user 216 as well as the infrastructure elements of a first traffic sign 214, a second traffic sign 218, and a pedestrian crossing 206, are related to one another in the knowledge graph in each case by means of a node that represents the class associated in each case with these objects. For this purpose, between nodes edges are used which represent the particular relationship.

In the example, the device 102 is designed to determine the prediction 108 in accordance with information 104 about the objects and in accordance with the representation 106 of the knowledge graph which comprises the first node 302, the second node 304, and the edge 306. The prediction 108 characterizes a behavior of at least one of the objects. The device 102 is designed to determine the state in particular for controlling the technical system 100 in accordance with the prediction 108.

The knowledge graph is not limited to these nodes and edges. In one embodiment, the knowledge graph comprises more than 100, more than 1,000, more than 10,000 or more than 100,000 nodes. In one embodiment, the knowledge graph comprises more than 100, more than 1,000, more than 10,000, or more than 100,000 edges. The example shown in FIG. 2 is a situation that is stored in the knowledge graph. The size of the knowledge graph depends, for example, on a number of situations stored in the knowledge graph.

FIG. 4 shows steps in a method for determining the state, in particular for controlling the technical system 100.

The method comprises a step 402.

In step 402, the representation 106 of the knowledge graph is determined.

The representation 106 of the knowledge graph is trained in a training, for example, in accordance with training data which comprise labeled information 104 about the objects or the environment. The information 104 originates, for example, from previously detected situations.

The training may allow for the use of an ontology. The ontology comprises, for example, rules that relate predefined classes to one another. The labeled information 104 is integrated into the knowledge graph, for example, in accordance with the ontology.

For example, the labeled information 104 comprises an image of a situation in the actually existing objects and their particular state or their relation to one another. The objects are classified, for example, by means of object recognition, i.e., in each case associated with a class. The state or the relationship is determined by means of the ontology, for example, in accordance with the class. The classes are associated with nodes in the knowledge graph which, in accordance with the relationship determined by means of the ontology, are connected by a new edge which represents this relationship. The labeled information 104 comprises, for example, an identifier that characterizes the prediction 108 for this situation. The representation 106 of the knowledge graph is generated, for example, by training an artificial neural network which is trained to output preferably the identifier as a prediction 108 for the labeled information 104.

Step 402 is optional. The following steps can also be carried out with an already trained representation 106.

In a step 404, the prediction 108, which characterizes a behavior of one of the objects, is determined in accordance with the information 104 about the objects and in accordance with the representation 106 of the knowledge graph.

In the representation 106, the first object is associated with the first class, wherein the first class is represented by the first node 302.

In the representation 106, the second object is associated with the second class, wherein the second class is represented by the second node 304.

The further node 308, which represents the environment information, and/or the further node 310, which represents the traffic regulation or the behavior pattern, are likewise taken into account in one embodiment.

The prediction 108 is determined, for example, in accordance with test data which comprise information 104, unknown in the training, about the objects or the environment, which are mapped onto the prediction 108 by the representation 106 of the knowledge graph, which representation is trained with the training data.

In a step 406, the state of the technical system 100 is determined in accordance with the prediction 108.

In a step 408, the state is output, or the technical system 100 is controlled in accordance with the state.

During operation of the technical system 100, the method can be used in real time to control the technical system 100 in accordance with information 104 which is being detected in real time.

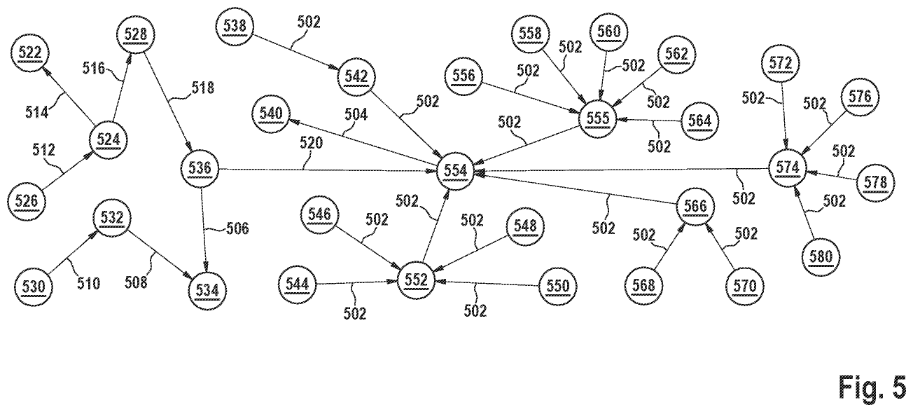

FIG. 5 represents an exemplary ontology comprising the dynamic relationships between road users and infrastructure elements. The ontology comprises the following relationships, which are in each case represented by an arrow which starts at a class of which the relationship to the class at which the arrow ends the arrow characterizes. The following arrows are provided in the example:
502: subclass of
504: has state
506: has data
508: has observation
510: has calibration
512: has trip
514: has vehicle
516: has sequence
518: has situation
520: has participant

The following classes are provided in the example:
522: at least partially autonomous vehicle
524: trip
526: map
528: sequence
530: sensor
532: calibration
534: data
536: situation
538: bicycle stand
540: state
542: static object
544: flat terrain
546: flat other
548: static vegetation
550: noise
552: background
554: participant
555: vehicle
556: passenger car
558: motorcycle
560: truck
562: bicycle
564: bus
566: moving object
568: warning beacon
570: roadway boundary
572: child
574: person
576: police officer
578: adult
580: construction worker

What is claimed is:

1. A computer-implemented method for determining a state of a technical system, the technical system including an infrastructure element or a road user, wherein a first node represents a first object which is the technical system, a second node represents a second object which is a further infrastructure element or a further road user, wherein an edge between the first node and the second node represents a relationship between the first and second objects, the method comprising:
determining a prediction which characterizes a behavior of one of the first and second objects, the determination being in accordance with information about the first and second objects and in accordance with a representation of a knowledge graph which includes the first node, the second node, and the edge; and
determining the state of the technical system in accordance with the prediction.

2. The method according to claim 1, further comprising:
controlling the technical system in accordance with the determined state.

3. The method according to claim 1, wherein: (i) the first object is associated with a first class and the first class is represented by the first node, or (ii) the second object is associated with a second class and the second class is represented by the second node.

4. The method according to claim 3, wherein the first class represents a passenger car, or a truck, or a three-wheeled vehicle, or a two-wheeled vehicle, or a horse rider, or a pedestrian, or a road segment, or an intersection, or a lane, or a guardrail, or a warning beacon, or a traffic light, or a footpath, or a road marking, or a roadway boundary.

5. The method according to claim 3, wherein the second class represents a passenger car, or a truck, or a three-wheeled vehicle, or a two-wheeled vehicle, or a horse rider, or a pedestrian, or a road segment, or an intersection, or a lane, or a guardrail, or a warning beacon, or a traffic light, or a footpath, or a road marking, or a roadway boundary.

6. The method according to claim 1, wherein the first and second objects are infrastructure elements associated with one another, wherein the edge represents a relationship of the infrastructure elements associated with one another, including interconnected lanes of a multi-lane road or a traffic light relevant to a lane, or a traffic sign ,or a traffic regulation.

7. The method according to claim 1, wherein the first and second objects are road users associated with one another, wherein the edge represents a relationship of the road users associated with one another, including road users located in the same lane or in different lanes of a multi-lane road.

8. The method according to claim 1, wherein the first object is an infrastructure element and the second object is a road user, and the infrastructure element and the road user are associated with one another, wherein the edge represents the relationship between the infrastructure element and the road user.

9. The method according to claim 1, wherein a further node represents environment information including: a time of day, or a day of the week, or visibility, or a temperature, or a roadway condition, or a roadway type, and wherein a further edge between the further node and the first node represents a relationship between the environment information and the first object.

10. The method according to claim 1, wherein a further node represents a traffic regulation or a behavior pattern, a further edge between the further node and the first node represents a relationship between the first object and the traffic regulation represented by the further node or the behavior pattern represented by the further node.

11. The method according to claim 1, wherein the representation of the knowledge graph, which includes the first and second nodes and the edge, is trained in accordance with training data including information about the first and second objects, wherein each of the first and second objects are classified in a respective class, wherein the edge which represents the relationship between the first and second nodes of the knowledge graph, which each represent one of the respective classes, is determined using an ontology which specifies relationships between the respective classes which the first and second nodes represent.

12. The method according to claim 11, wherein the prediction is determined in accordance with test data which include information, unknown during training, about the first and second objects or an environment, which are mapped onto the prediction by the representation of the knowledge graph trained with training data.

13. A device for determining a state of a technical system, comprising:
at least one processor; and
at least one non-transitory memory, wherein the at least one memory includes instructions for determining a state of a technical system, the technical system including an infrastructure element or a road user, wherein a first node represents a first object which is the technical system, a second node represents a second object which is a further infrastructure element or a further road user, wherein an edge between the first node and the second node represents a relationship between the first and second objects, the instructions, when executed by the at least one processor, causing the at least one processor to perform the following steps:
determining a prediction which characterizes a behavior of one of the first and second objects, the determination being in accordance with information about the first and second objects and in accordance with a representation of a knowledge graph which includes the first node, the second node, and the edge, and
determining the state of the technical system in accordance with the prediction.

14. A non-transitory computer-readable medium on which is stored a computer program including computer-readable instructions for determining a state of a technical system, the technical system including an infrastructure element or a road user, wherein a first node represents a first object which is the technical system, a second node represents a second object which is a further infrastructure element or a further road user, wherein an edge between the first node and the second node represents a relationship between the first and second objects, the instructions, when executed by at least one processor, causing the at least one processor to perform the following steps:
determining a prediction which characterizes a behavior of one of the first and second objects, the determination being in accordance with information about the first and second objects and in accordance with a representation of a knowledge graph which includes the first node, the second node, and the edge, and
determining the state of the technical system in accordance with the prediction.
